(19) United States
(12) Patent Application Publication
(10) Pub. No.: US 2025/0269789 A1
(43) Pub. Date: Aug. 28, 2025

(54) VEHICLE PARKING INDICATOR ATTACHMENT

(71) Applicant: Loading Lane LLC, Spokane, WA (US)

(72) Inventors: Ashley Graham Plischke, Spokane, WA (US); Chase Plischke, Spokane, WA (US)

(21) Appl. No.: 19/060,310

(22) Filed: Feb. 21, 2025

Related U.S. Application Data
(60) Provisional application No. 63/556,757, filed on Feb. 22, 2024.

(51) Int. Cl. B60Q 1/48; B60Q 1/26; F16B 47/00

(52) U.S. Cl. CPC B60Q 1/484; B60Q 1/2615; B60Q 1/2669; F16B 47/006

(57) ABSTRACT

A vehicle parking indicator device to provide an indication of space needed for access into a vehicle. The device includes an interior attachment device securable to an interior of a vehicle door. The device may include an exterior attachment device coupleable to the interior attachment device to releasably secure the exterior attachment device to a window of a vehicle. The device may include a frame connected to the exterior attachment device and configured to support a placard, the frame positionable between a first position and a second position, wherein in the first position the frame is substantially perpendicular to the window of the vehicle and in the second position the frame is substantially parallel to the window of the vehicle.

### CROSS REFERENCE TO RELATED APPLICATIONS

This application claims priority to U.S. Provisional Application No. 63/556,757, filed Feb. 22, 2024, the entire disclosure of which is incorporated herein by reference and for all purposes.

### BACKGROUND

The use of automobiles has become ubiquitous in everyday life. One of the most tenuous environments for the everyday driver is the modern parking lot, which is often filled with rushed travelers, eager consumers, and not enough space. As a result, individuals often compromise adequate access to their vehicle(s), whether by affirmative choice or more commonly by the actions of other drivers. Due to this ever-increasing lack of space and the necessity for an individual to have adequate access to their vehicle, existing methods for ensuring this adequate access are lacking.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1A illustrates a frontal view of an example vehicle indicator system showing the system when engaged, according to at least one example.

FIG. 1B illustrates a frontal view of the example system of FIG. 1A showing the system when disengaged, according to at least one example.

FIG. 2A illustrates an interior perspective view of a vehicle parking indicator attachment, according to at least one example.

FIG. 2B illustrates an interior perspective view of an example system showing the attachment device anchored on the vehicle's window, according to at least one example.

FIG. 2C illustrates an example system for a vehicle indicator system, according to at least one example.

FIG. 2D illustrates an exterior perspective view of an example vehicle indicator system, according to at least one example.

FIG. 3A illustrates an interior perspective view of an example vehicle indicator system showing the attachment device anchored on the vehicle's door, according to at least one example.

FIG. 3B illustrates an interior perspective view of an example vehicle indicator system, according to at least one example.

FIG. 3C illustrates a perspective view of an example vehicle indicator system, according to at least one example.

FIG. 3D illustrates an exterior perspective view of an example vehicle indicator system, according to at least one example.

FIG. 4A illustrates an interior view of an example vehicle indicator system showing the attachment devices anchored to the vehicle's door handle(s), according to at least one example.

FIG. 4B illustrates a perspective view of an example vehicle indicator system, according to at least one example.

FIG. 5A illustrates an interior view of an example vehicle indicator system showing the attachment device anchored to the vehicle's door handle(s), according to at least one example.

FIG. 5B illustrates a perspective view of an example vehicle indicator system, according to at least one example.

FIG. 6A illustrates an exterior perspective view of an example vehicle indicator system showing the connecting strap is unstretched, according to at least one example.

FIG. 6B illustrates an exterior perspective view of an example vehicle indicator system showing the connecting strap is stretched, according to at least one example.

FIG. 6C illustrates a perspective view of an example vehicle indicator system, according to at least one example.

FIG. 7 illustrates an exterior perspective view of an example vehicle indicator system showing the system anchored to a vehicle's roof rack, according to at least one example.

FIG. 8A illustrates an interior perspective view of an example vehicle indicator system showing the system is anchored between the vehicle's door frame and body, according to at least one example.

FIG. 8B illustrates an exterior perspective view of an example vehicle indicator system, according to at least one example.

FIGS. 9A-9E illustrate views of a vehicle indicator system, according to at least one example.

FIG. 10A illustrates a hinge system of a vehicle indicator system, according to at least one example.

FIG. 10B illustrates a hinge system of a vehicle indicator system, according to at least one example.

FIG. 11A illustrates a first component of a hinge system of a vehicle indicator system, according to at least one example.

FIG. 11B illustrates a first component of a hinge system of a vehicle indicator system, according to at least one example.

FIGS. 12A-12D illustrate views of a vehicle indicator system, according to at least one example.

FIGS. 13A-13B illustrate views of a vehicle indicator system affixed to a vehicle door using a magnetic attachment, according to at least one example.

### DETAILED DESCRIPTION

Systems and devices described herein are related to an operator's ability to effectively, efficiently, and adequately ensure the required space to enter and exit a vehicle. Whether by affirmative actions of the individual operator or by the unfortunate actions of others, the ability to adequately enter and exit a vehicle can be severely limited. The systems and devices descried herein allow the vehicle's operator to make other drivers aware of the requisite space needed to enter and exit their vehicle.

While an individual person entering and exiting a vehicle is not the most spatially demanding task, there are numerous other tasks that require far greater space and access to the vehicle's interior in order to be completed. Tasks, such as loading and unloading baby carriers and the placement and removal of large ridged/unconforming items, are a few nonlimiting examples of such tasks. Because certain actions require adequate spacing, usually in the form of opening the vehicle's side doors, it is increasingly necessary for individuals to ensure adequate access to that space as without it, one may be unable to complete their objective. Thus, this disclosure describes systems and devices for alerting other vehicle operators of the required space necessary to access one's vehicle.

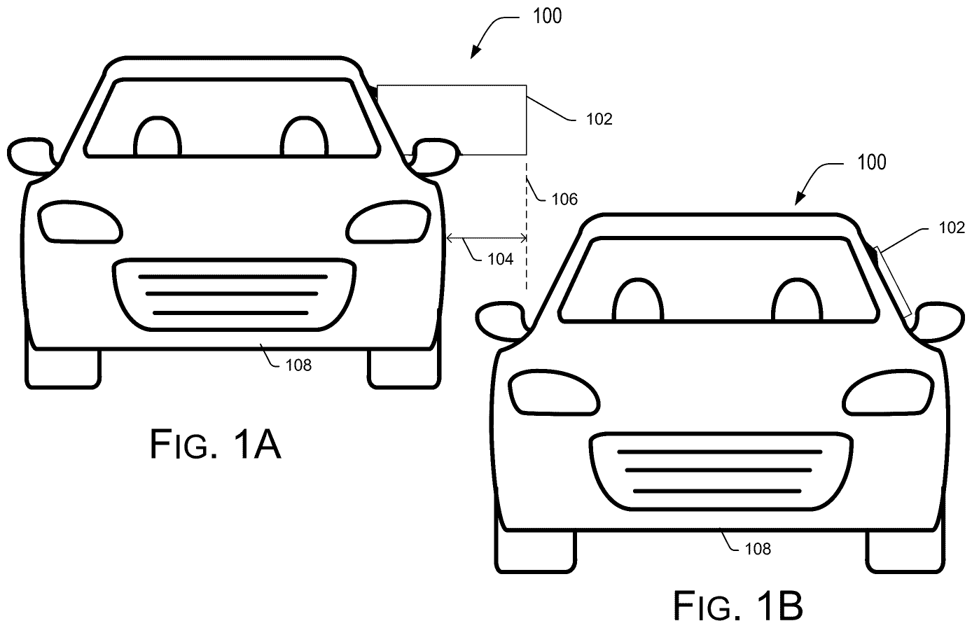

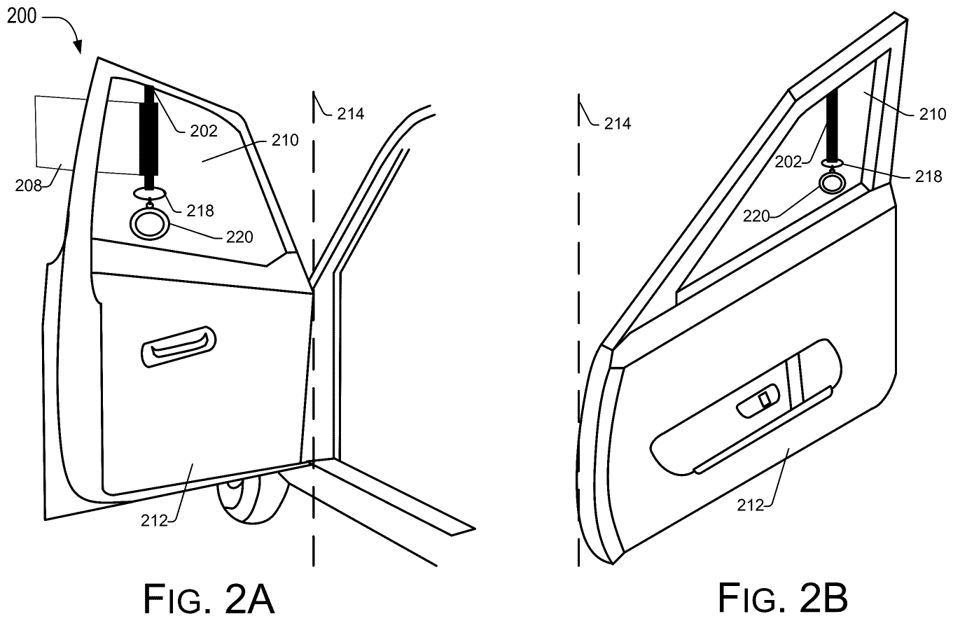

FIGS. 1A-B illustrate a frontal perspective view of the vehicle parking indicator 100 and its extended portion 102 in an engaged mode (as shown in FIG. 1A) and disengaged mode (as shown in FIG. 1B). The vehicle parking indicator 100 connects to and extends from a door of a vehicle 108. When in use, the extended portion 102 of the vehicle parking indicator 100 may go from a disengaged mode, wherein the extended portion 102 of the device is kept parallel to the vehicle's door(s), to an engaged mode, wherein the exterior portion of the vehicle parking indicator 100 is kept substantially perpendicular to a door of the vehicle 108. The purpose of the exterior portion of the vehicle parking indicator 100 is to notify fellow vehicle operators (e.g., of adjacent vehicles) of the adequate space necessary to effectively access the vehicle. For example, in a parking lot or other such environment, a driver may need space to ensure that they are able to load the vehicle with materials, car seats, aid children, or otherwise access the interior of the vehicle 108 through the door.

In the example illustrated in FIGS. 1A-1B, when the vehicle parking indicator 100 is extended, the outer edge 106 of the vehicle parking indicator 100 extends a distance 104 from the side of the vehicle 108. The distance 104 may be in a range of twelve inches to twenty-four inches or more and may provide a visible indicator for an adjacent vehicle parking next to the vehicle 108 to leave sufficient space for the drive and/or passengers of the vehicle 108 to access the interior of the vehicle 108 and provide clearance for opening the door of the vehicle 108. As depicted in FIG. 1B, the vehicle parking indicator 100 may fold to be substantially parallel with the side of the vehicle 108, for example to enable driving of the vehicle 108 while the vehicle parking indicator 100 is connected to the vehicle 108 but in a stowed position.

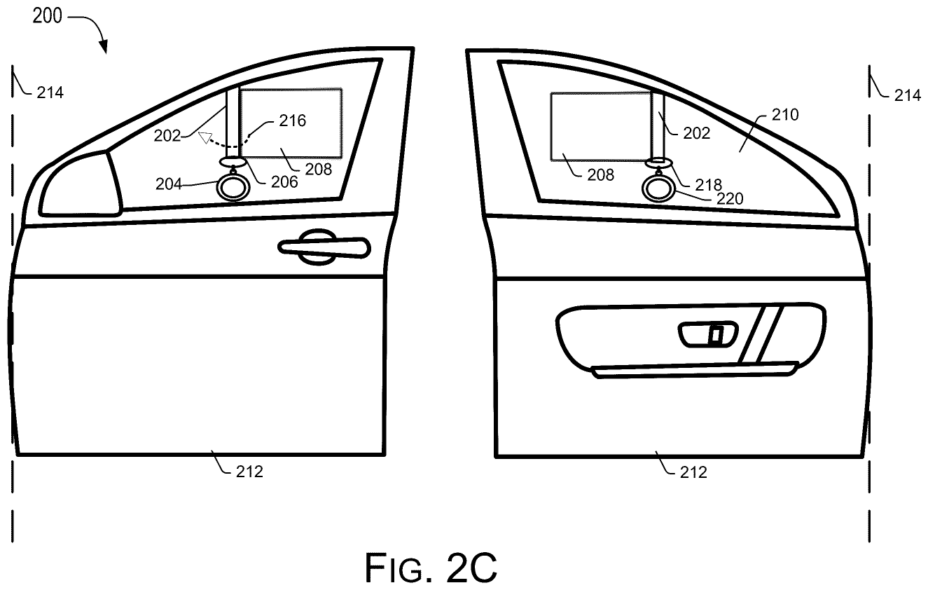

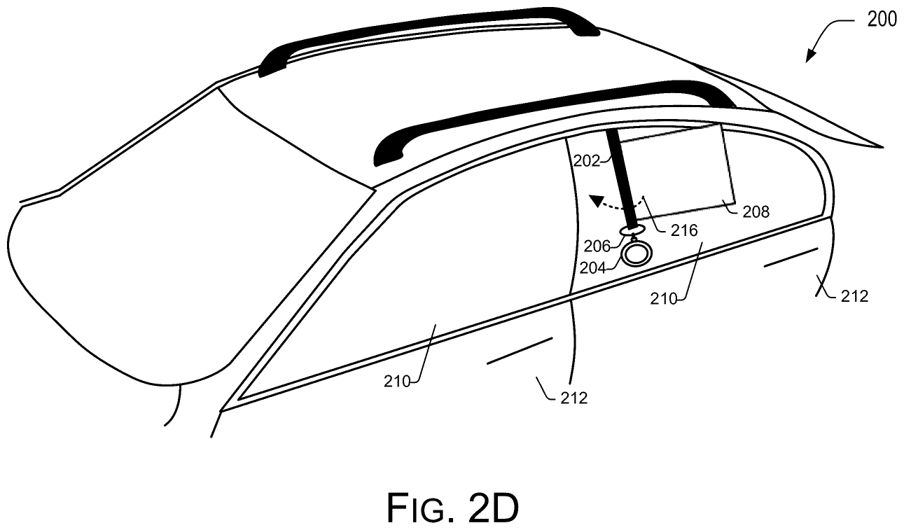

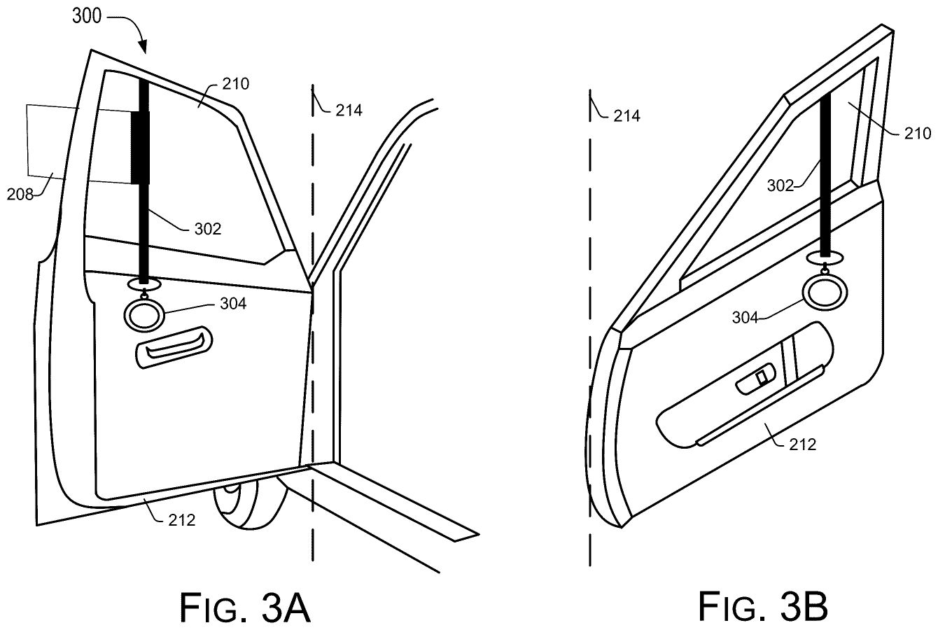

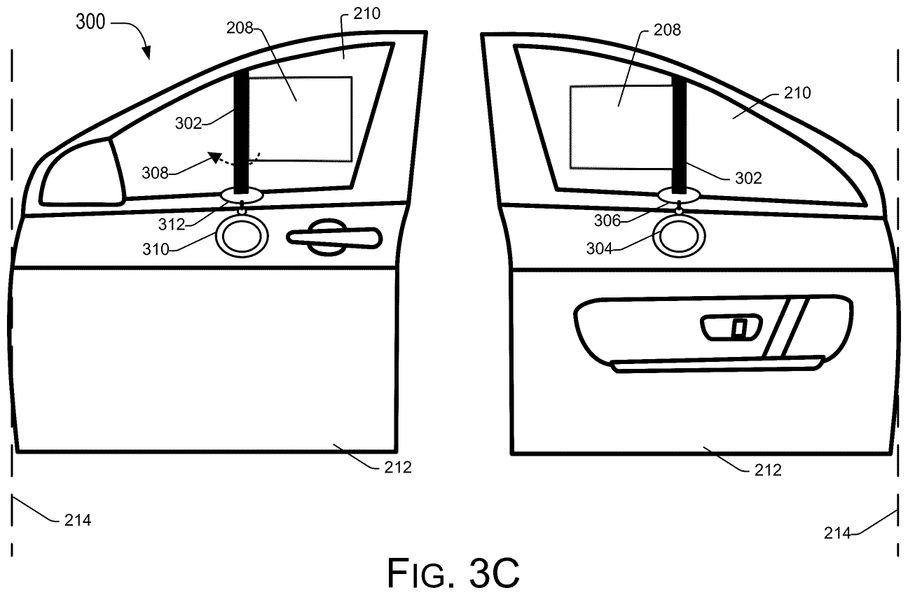

FIGS. 2A-B illustrate an interior perspective view of a vehicle parking indicator 200, which may include an attachment device 220 and a strap 202. The vehicle parking indicator 200 may be an example or embodiment of a vehicle parking indicator attachment and may include one or more components such as described herein with respect to the embodiments shown in the figures. In an embodiment, the vehicle parking indicator 200 may attach via the attachment device 220 to the interior of a window 210. The attachment device 220 may be include suction cup, clamp, lock, magnetic attachment, or physical lever, to name a few nonlimiting examples. The attachment device 220 is securable to the vehicle's window, and the strap 202 may extend to the exterior of the vehicle via the space between the window and the window frame or between the door 212 and the door frame, to name a few non limiting examples. In this manner, the vehicle parking indicator 200 may removably and releasably attach to the window 210 of the door 212. The door 212 may pivot relative to the vehicle body about pivot 214 as the door is opened. Accordingly, the vehicle parking indicator 200 may be used to ensure that as vehicles are parked there is sufficient space for the door 212 to open and enable a drive to enter, exit, and/or load the vehicle.

The vehicle parking indicator 200 includes the strap 202, attachment device 204 for the exterior of the window 210, connection 206, placard 208, attachment device 220 for the interior of the window 210, connection 218, and other such intervening components. The connection 206 and/or connection 218 may enable adjustment of the length of the strap 202 to position the placard 208 on the outside of the window 210. The connection 206 and/or the connection 218 may include adjustment devices for the end of the strap 202 to enable length adjustment of the strap 202. The attachment device 220 may be positioned on an interior of the window 210 and a corresponding attachment device 204 may be positioned on an exterior surface of the window 210. The strap 202 couples the attachment devices together to secure the placard 208 to the window 210 and prevents unauthorized removal of the placard 208 from the window 210.

FIGS. 2C-D further illustrate an example of the vehicle parking indicator 200 as shown from an interior and exterior view of the vehicle. As previously stated, the vehicle parking indicator 200 may attach to the interior of the vehicle and to the exterior of the window 210 via the attachment device 220. With the attachment device 220 secured to the window 210, the strap 202 may extend to the exterior of the vehicle 108 via the space between the window 210 and the window frame and/or between the door 212 and the door frame, as a nonlimiting example, to the exterior portion of the vehicle parking indicator 200 including the attachment device 204, connection 206, and other such components. The portions of the vehicle parking indicator 200 may be made of various materials, such as plastic or metal, coated in various materials and pigments, such as rubberized coatings, bright paints, and/or reflective coatings, to name a few nonlimiting examples. The exterior portion of the vehicle parking indicator 200 provides for notifying fellow vehicle operators of adequate space necessary to effectively access the vehicle. When used, the exterior portion of the vehicle parking indicator 200, including the placard 208, may go from a disengaged mode, wherein the exterior portion of the device is kept parallel to the door 212, to an engaged mode, wherein the exterior portion of the device is kept perpendicular to the door 212. As such, the placard 208 may pivot or rotate along direction 216 from the engaged to disengaged position and vice versa.

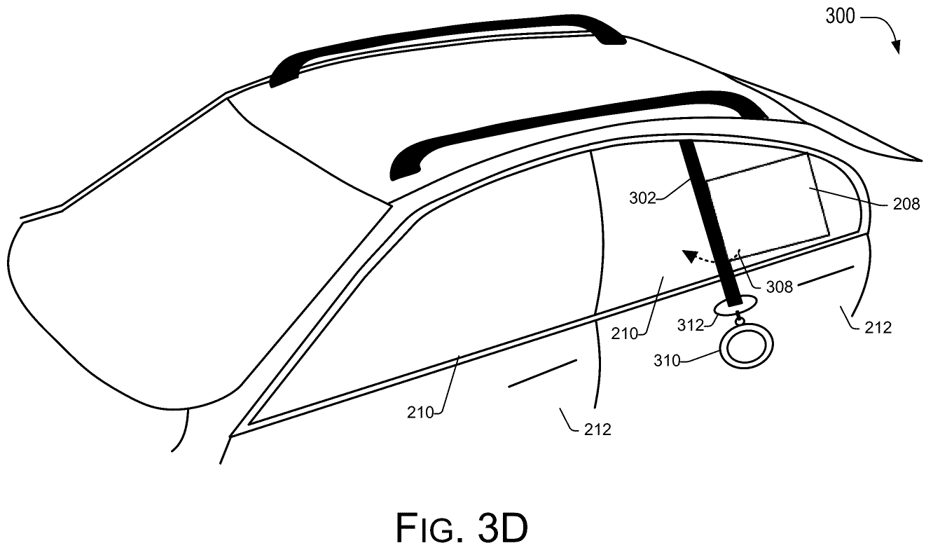

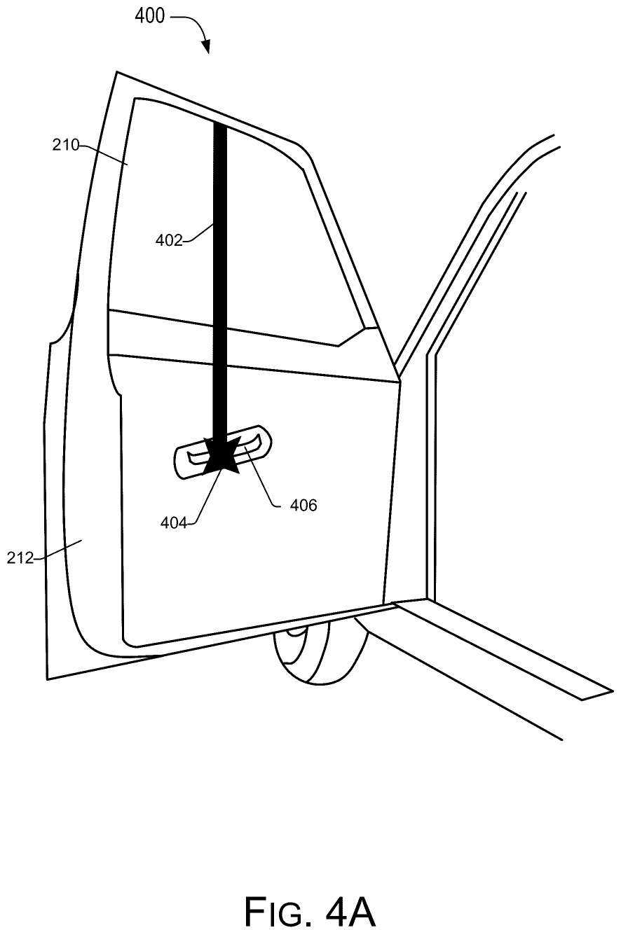

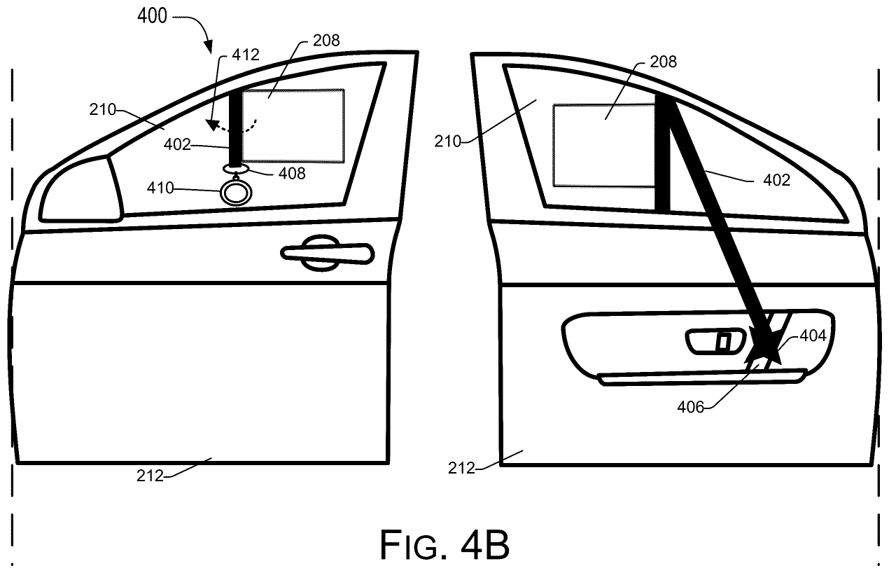

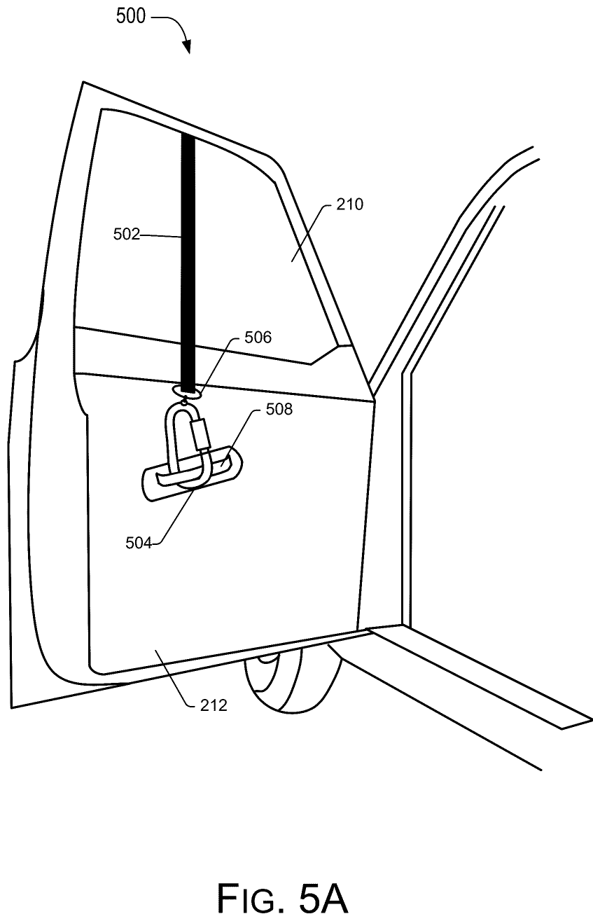

FIGS. 3A-B illustrate an interior perspective view of a vehicle parking indicator attachment 300, which may include an attachment device 304 and a strap 302. In an embodiment, the vehicle parking indicator attachment 300 may attach via the attachment device 304 to the interior of a vehicle's door. The attachment device 304 may include a suction cup, clamp, lock, magnet, Velcro™ or a physical component such as a hook or latch, to name a few nonlimiting examples. The attachment device 304 is releasably securable to the door 212, the strap 302 may extend to the exterior of the vehicle via a space between the window 210 and the window frame or between the door and the door frame, to name a few non limiting examples. The strap 302, attachment device 304, and placard 208 may be similar or identical to the components shown and described with respect to FIGS. 2A-D or other embodiments described and shown herein.

FIGS. 3C-D further illustrate an example of the vehicle parking indicator attachment 300. As previously stated, the vehicle parking indicator attachment 300 may attach to the interior of the door 212 and the exterior of the door 212 via the attachment device 304 with a connector 306 and a corresponding attachment device 310 and connector 312. Once the attachment device 204 is secured to the vehicle's door, a strap 302 may extend to the exterior of the vehicle via the space between the window and vehicle's window frame, as a nonlimiting example, to the exterior portion of the vehicle parking indicator attachment 300. Though described herein as a strap, the strap 302 may include components capable of connecting the attachment device 304 and the attachment device 310 together and passing through a gap in the window frame and/or door frame. The components of the vehicle parking indicator attachment 300 may be made of various materials, such as plastic or metal, coated in various materials and pigments, such as rubberized coatings, bright paints or reflective coatings, to name a few nonlimiting examples. The purpose of the exterior portion of the vehicle parking indicator attachment 300 is to notify fellow vehicle operators of the adequate space necessary to effectively access the notifying vehicle. When used, the exterior portion of the vehicle parking indicator attachment 300 may rotate about direction 308 from a disengaged mode, wherein the exterior portion of the device is kept substantially parallel to the door 212, to an engaged mode, wherein the exterior portion of the device is kept substantially perpendicular to the door 212. As used herein, substantially parallel and substantially perpendicular correspond to directions that are approximately parallel or perpendicular but may not be exactly parallel or perpendicular. As depicted herein, the door 212 may be a front or rear door of the vehicle 108.

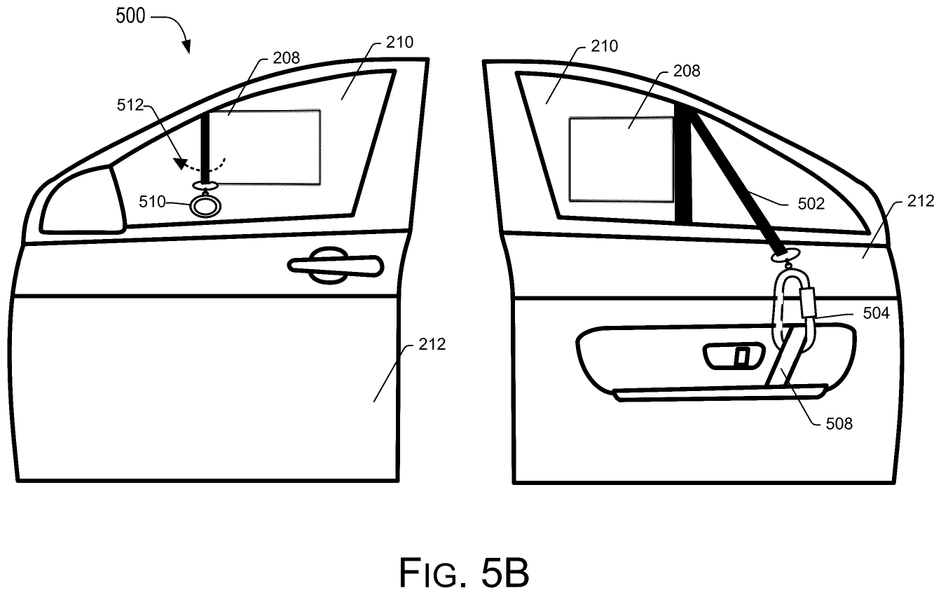

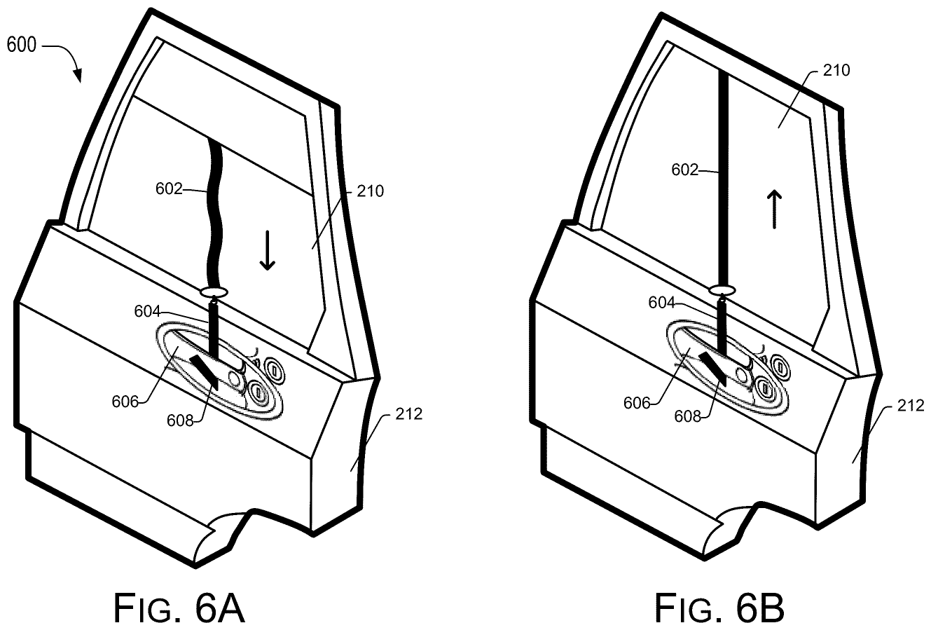

FIGS. 4A-B illustrate an interior perspective view of a vehicle parking indicator attachment 400, which may include an attachment device 404 and a strap 402. In an embodiment, the vehicle parking indicator attachment 400 may attach via the attachment device 404 to the vehicle's interior door handle 406. The attachment device 404 may be a suction cup, clamp, lock, physical lever, hook and loop fastener, magnet, connector, or be physically tied to portions of the vehicle such as the handle 406, to name a few nonlimiting examples. With the attachment device 404 secured to the interior of the door 212, the strap 402 may extend to the exterior of the vehicle via the space between the window and the window frame or between the door and the door frame, to name a few non limiting examples. As shown in the figures, on the exterior of the window 210 an attachment device 410 and connection 408 couple to the strap 402 to secure the placard 208 to the exterior of the door 212. The placard 208 may then pivot along direction 412 to rotate outwards into a position substantially perpendicular to the door 212.

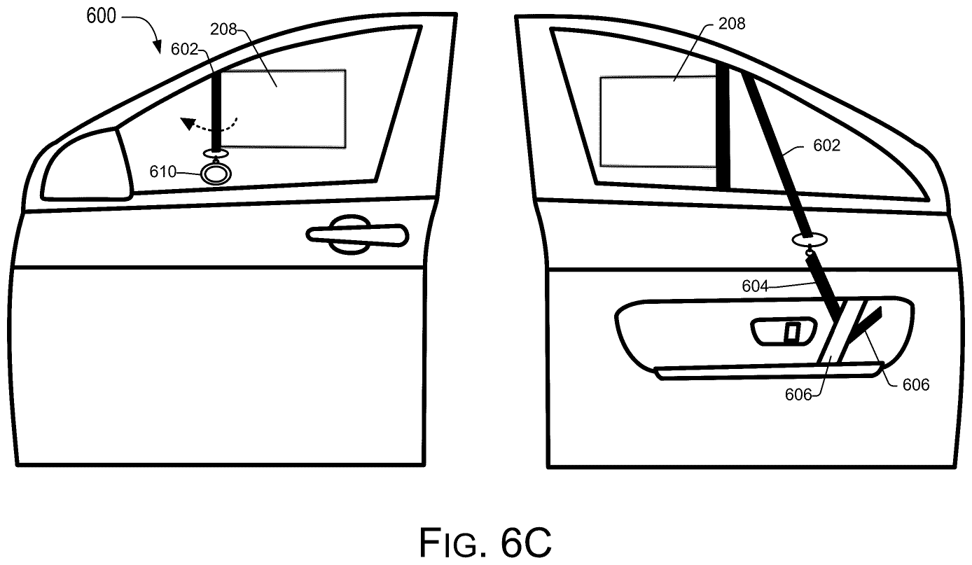

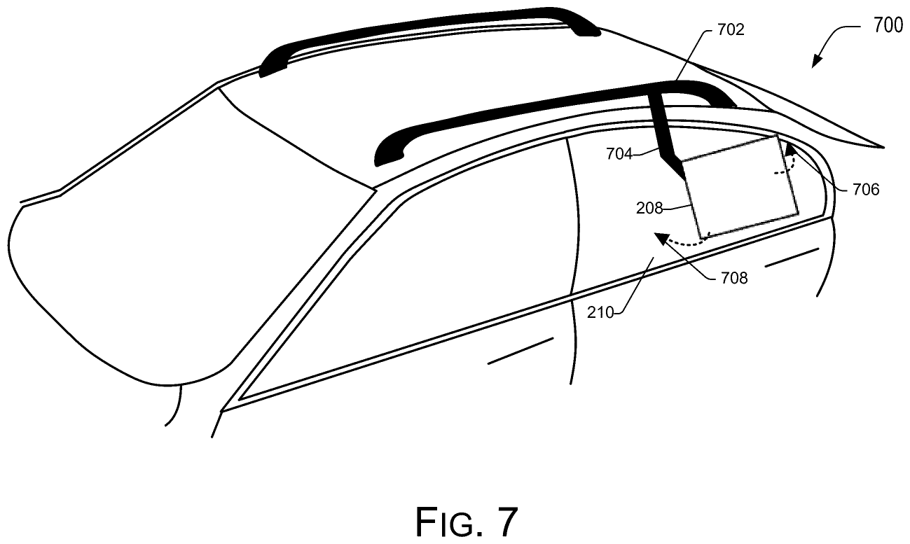

FIGS. 5A-B illustrate an interior perspective view of a vehicle parking indicator attachment 500, which may include an attachment device 504, a connector 506, and a strap 502. In an embodiment, the vehicle parking indicator attachment 500 may attach via the attachment device 504 to the door handle 508. The attachment device 504 may include a suction cup, clamp, lock, physical lever, carabiner, coupling device, or be physically tied to portions of the vehicle, to name a few nonlimiting examples. With the attachment device 504 secured to the door handle 508, the strap 502 may extend to the exterior of the vehicle via the space between the window and the window frame or between the door and the door frame, to name a few non limiting examples. As shown in the figures, on the exterior of the window 210 an attachment device 510 and couple to the strap 502 to secure the placard 208 to the exterior of the door 212. The placard 208 may then pivot along direction 512 to rotate outwards into a position substantially perpendicular to the door 212.

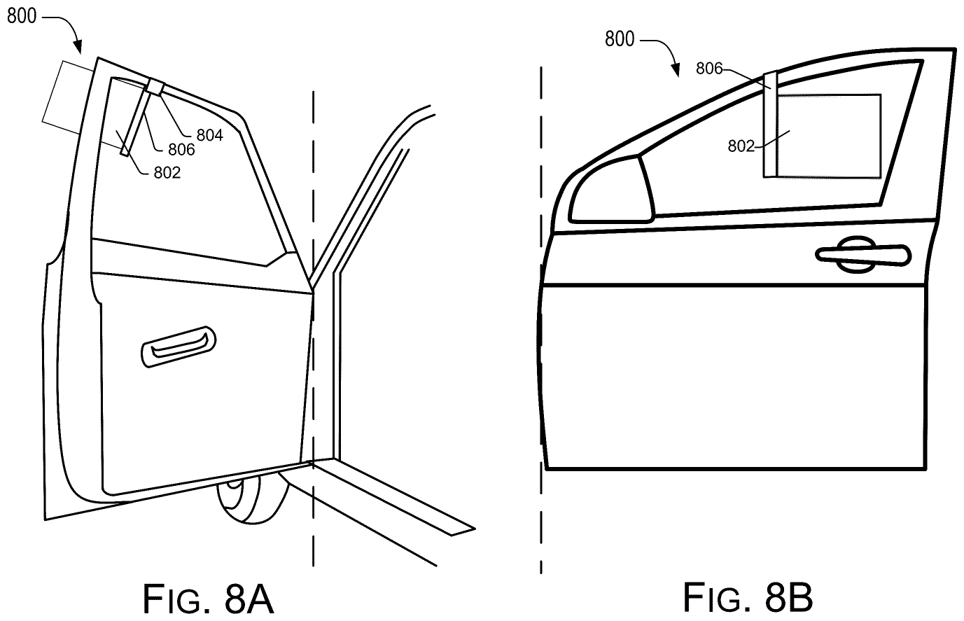

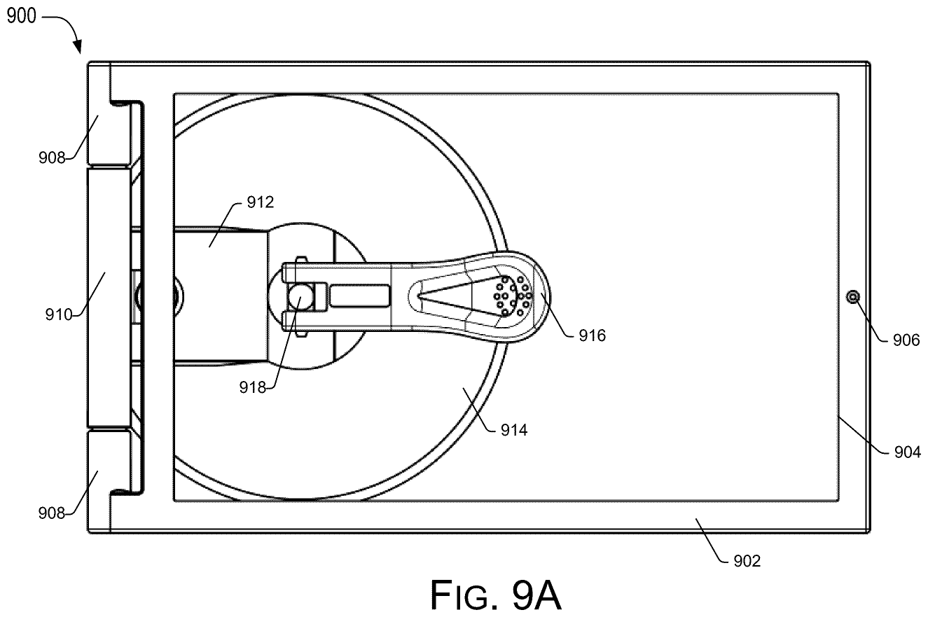

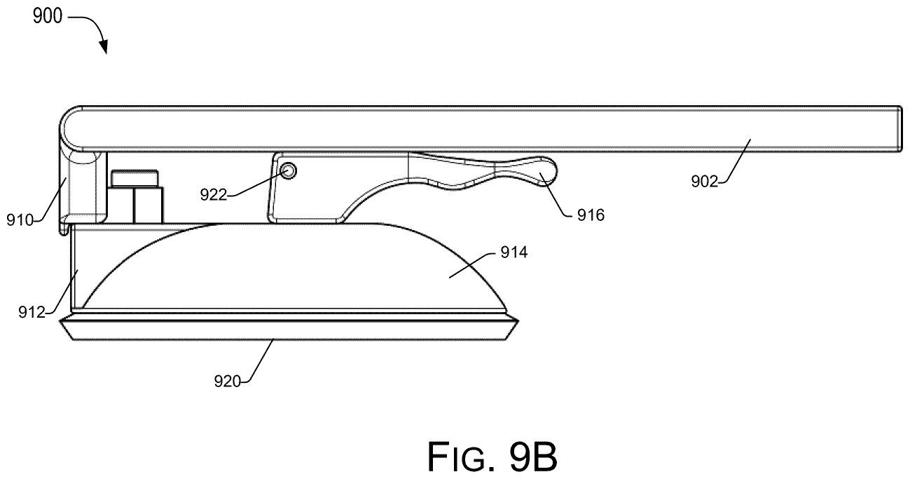

FIGS. 6A-C illustrate an exterior perspective view of a vehicle parking indicator attachment 600, which may include an attachment device 604 and a strap 602. In an embodiment, the vehicle parking indicator attachment 600 may attach via the attachment device 604 to the door handle 606. The attachment device 604 may include a suction cup, clamp, lock, lever, hook 608, or be physically tied to portions of the vehicle, to name a few nonlimiting examples. With the attachment device 604 is secured to the door handle 606, a strap 602 may extend to the exterior of the vehicle via the space between the window and the window frame or between the door and the door frame, to name a few non limiting examples. In an embodiment, the strap 602 may be elastic and capable of stretching. In such examples, the strap 602 may connect the interior and exterior portions of the vehicle parking indicator attachment 600 via the space between the window and the window frame. When the window 210 is lowered (as depicted in FIG. 6A), the strap 602 is under no tension (e.g., is not secured). When the window 210 is raised (as depicted in FIG. 6B), the strap 602 is under tension, thereby securing the vehicle parking indicator attachment 600 to vehicle. As shown in the figures, on the exterior of the window 210 an attachment device 610 and couples to the strap 602 to secure the placard 208 to the exterior of the door 212. The placard 208 may then pivot to rotate outwards into a position substantially perpendicular to the door 212.

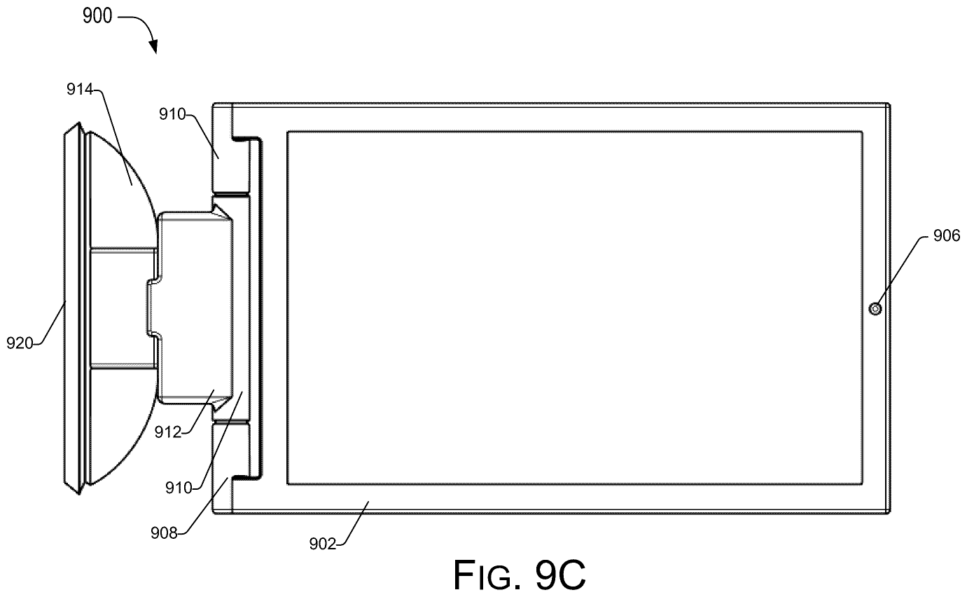

FIG. 7 illustrates an exterior perspective view of a vehicle parking indicator attachment 700, which may include an attachment device 704 to connect to an exterior portion 702 of the vehicle such as a roof rack or other such structure. In an embodiment, the vehicle parking indicator attachment 700 may attach via the attachment device 704 to the vehicle's exterior roof rack, or roof rack equivalent. The attachment device 704 may be a suction cup, clamp, lock, physical lever, or be physically bolted to portions of the vehicle, such as a roof rack, to name a few nonlimiting examples. Once the attachment device 704 is secured to the vehicle's roof rack, an exterior portion of the vehicle parking indicator attachment, such as the placard 208, may extend from the attachment device 704. When in use, the exterior portion of the vehicle parking indicator attachment 700 may rotate from a disengaged mode, wherein the exterior portion of the device is substantially parallel to the window 210, to an engaged mode, wherein the exterior portion of the device is substantially perpendicular to the window 210. The placard 208 may rotate in a first direction 706 and/or in a second direction 708 through a pivoting connection of the placard with the attachment device 704 to enable movement and rotation of the placard 208 relative to the window 210.

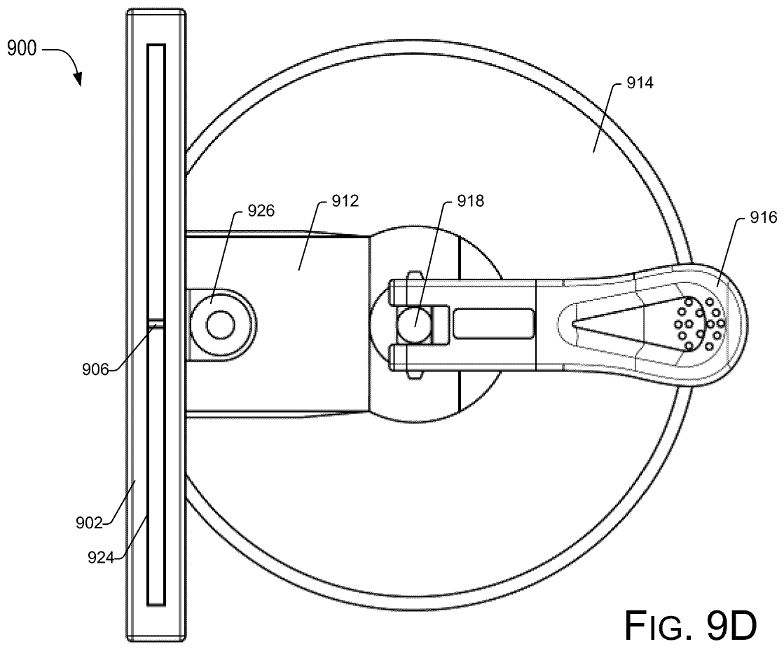

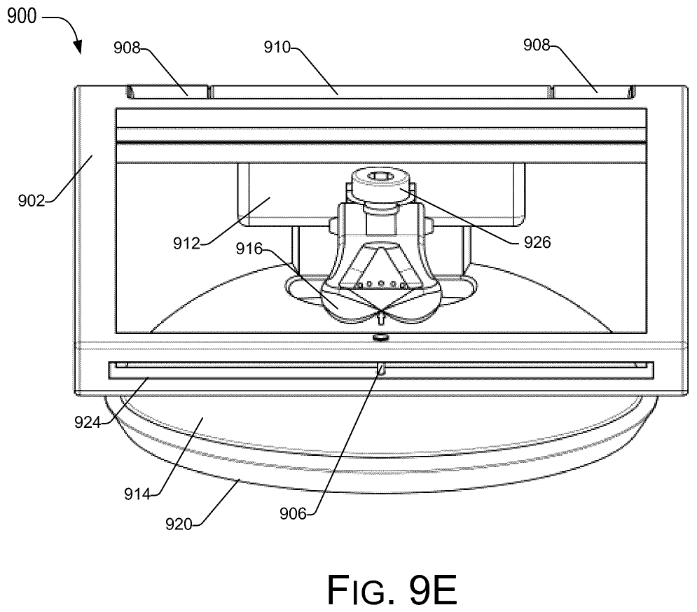

FIGS. 8A-B illustrate a perspective view of a vehicle parking indicator attachment 800, which may include an attachment device 804 and an exterior portion of the vehicle parking indicator attachment 800. In an embodiment, the vehicle parking indicator attachment 800 may attach via the attachment device 804 to the vehicle's door via a space between the door and the door frame. The attachment device 804 may include a suction cup, clamp, lock, physical lever, magnet, or a rigid hook, to name a few nonlimiting examples. Further, the attachment device 804, if in the form of a rigid hook, may be made of various materials such as plastics or metals, to name a few nonlimiting examples. With the attachment device 804 secured to the vehicle via the space between the door and the door frame, an exterior portion of the vehicle parking indicator attachment 800 may be present in either an engaged or disengaged mode. A base 806 of a placard 802 may enable rotation or pivoting of the placard relative to the window of the door.

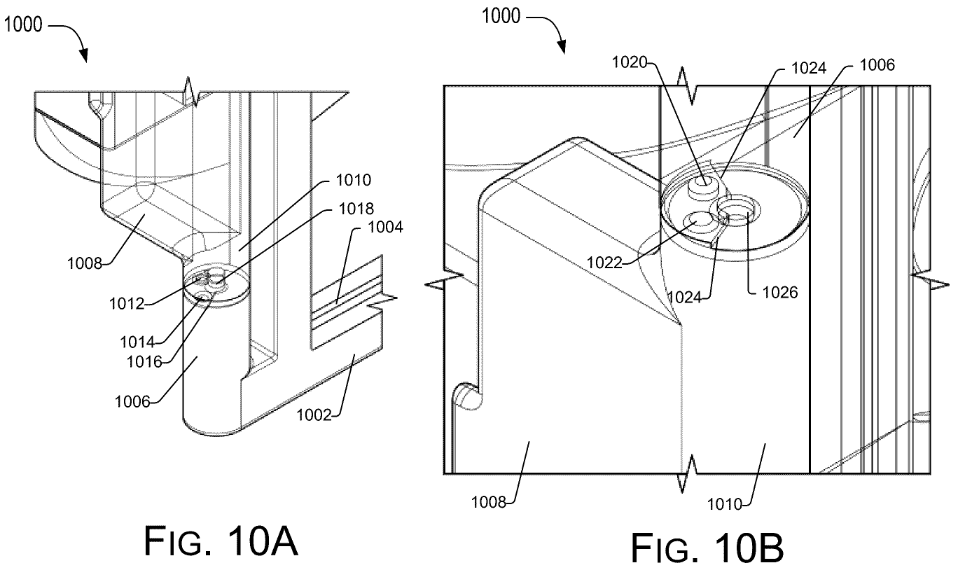

FIGS. 9A-9E illustrate views of a vehicle indicator system 900, according to at least one example. The vehicle indicator system 900 may be an example of a vehicle parking indicator attachment as described herein. The vehicle indicator system 900 may be formed of various materials such as metals, plastics, rubber, composites, and other such suitable materials. The vehicle indicator system 900 includes a frame 902 that may receive or support a sign, placard, or other informational device such as a display and couples to the exterior of a window of a door. The frame 902 defines a perimeter with a channel 904 to receive a sign or other such component within the frame 902 and a pin 906 to retain the sign or other such component within the frame 902 and channel 904. For example, as depicted in FIG. 9D, the frame 902 defines a slot 924 in an end of the frame 902 with the pin 906 extending across the slot 924 and removable such that when the pin 906 is removed a sign or placard may be inserted into the slot 924 to rest in the channel 904 and be secured within the frame by replacing the pin 906.

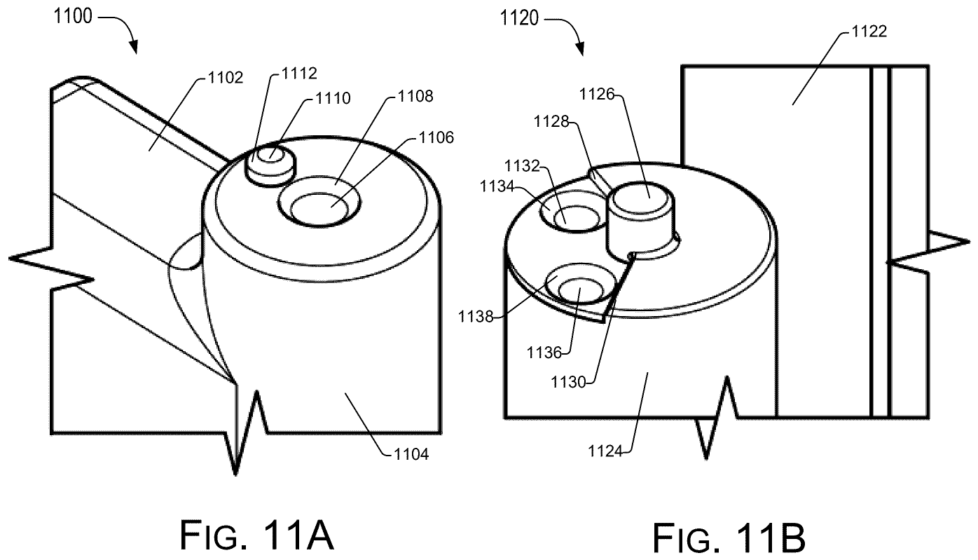

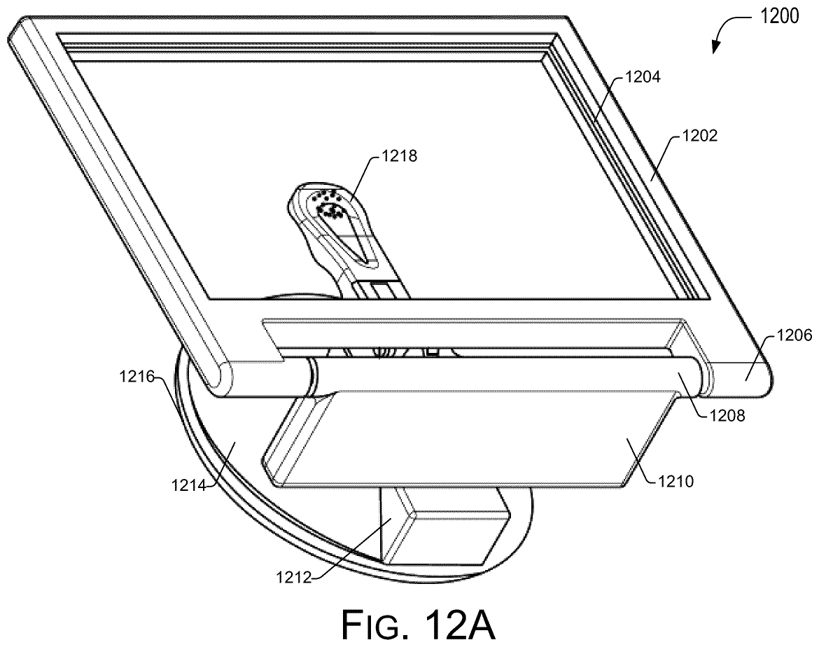

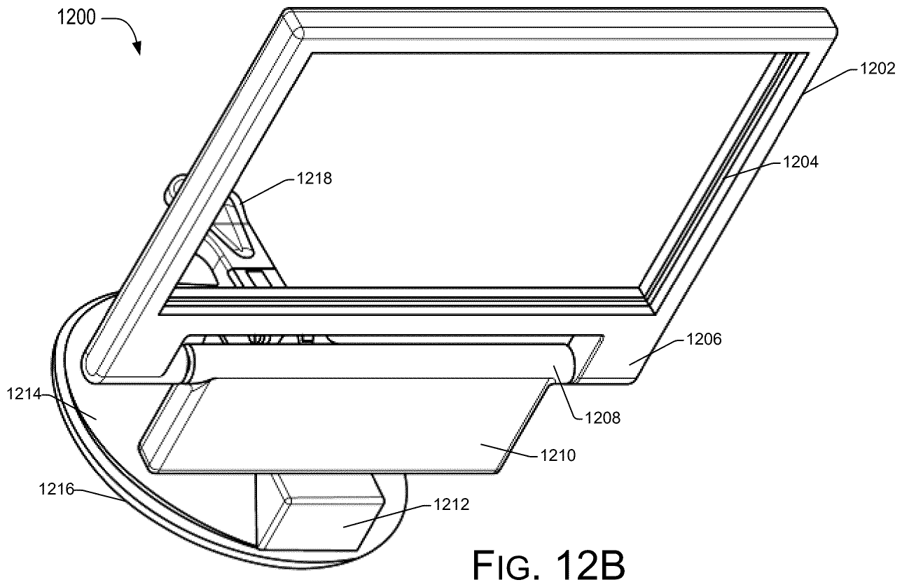

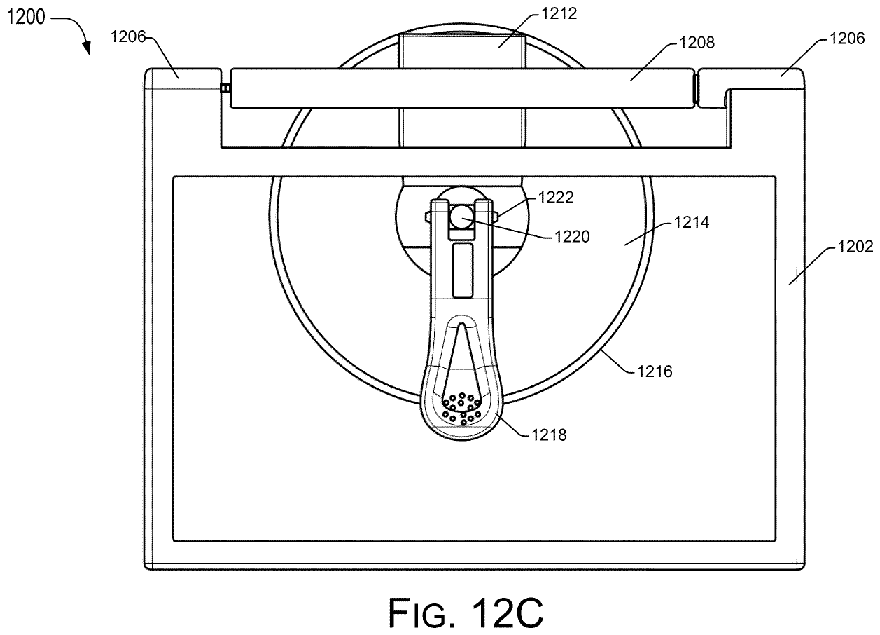

The vehicle indicator system 900 includes a hinge system that connects the frame 902 to a base 912. The hinge system may include the components shown and described with respect to FIGS. 10-11 herein. The hinge system includes first hinge components 908 and second hinge component 910. The hinge system enables rotation of the first hinge components 908 (and the corresponding frame 902) relative to the base 912 to enable the frame 902 to be pivoted from an extended position to a stowed position and/or to other positions.

The base 912 connects the frame 902 to an attachment device though a connector 926 such as a threaded connector (e.g., a bolt), with the attachment device depicted herein as a suction cup. The attachment device shown herein includes a cup portion 914, handle 916 for actuating a diaphragm that extends within the cup portion 914 from an edge 920, and a pin 918 connected to the diaphragm of the suction cup to deform the suction cup and cause a vacuum to be formed within the cup portion 914 to secure the attachment device to an exterior of a window or vehicle panel. The pin 918 is connected to the handle 916 through a pin 922 such that rotation of the handle 916 causes the pin 918 to move relative to the cup portion 914 and diaphragm and cause the suction cup to create a vacuum within the cup portion 914 and secure the attachment device to the vehicle.

FIGS. 9A, 9B, and 9E illustrate the vehicle indicator system 900 in a folded configuration folded into a stowed configuration using the hinge system. The vehicle indicator system 900 is shown in FIGS. 9C and 9D in an extended configuration with the frame 902 rotated outwards and extending substantially perpendicular from a side of the vehicle.

FIG. 10A illustrates a hinge system 1000 of a vehicle indicator system, according to at least one example. The hinge system 1000 may be part of the vehicle parking indicator system described herein and may enable a placard or frame 1002 having a channel 1004 for securing a sign within the frame 1002 to pivot relative to an attachment device and enable the placard to be rotated relative to the vehicle. The hinge system 1000 further includes a first hinge component 1006 and a second hinge component 1010 that form a hinge for rotating the frame 1002. The first hinge component 1006 and the second hinge component 1010 include components that interact to enable rotation between set positions. In FIG. 10A, the second hinge component 1008 is shown transparent to enable visibility of the components of the first hinge component 1006. The components include detents 1012 and 1014 and stop 1016 that may prevent over-rotation of the hinge system as well as pivot 1018. The detents 1012 and 1014 may interact with indentations in the second hinge component 1008 to provide positive stops when the detents engage with the indentations, for example at a stored and extended position as the hinge system rotates about the pivot 1018.

FIG. 10B illustrates a hinge system 1000 of a vehicle indicator system, according to at least one example. The hinge system 1000 depicted in FIG. 10B is shown with the first hinge component 1006 transparent to enable visibility of the features and components of the second hinge component 1008. The components include indentations 1020 and 1022 as well as stops 1024 and a pocket 1026 to receive pivot 1018.

FIG. 11A illustrates a first component 1104 of a hinge system 1100 of a vehicle indicator system, according to at least one example. The hinge system 1100 includes a base portion 1102 of the vehicle parking indicator system. The first component 1104 includes a pocket 1106 to receive a pivot of a hinge component and the pocket 1106 may include a chamfer 1108 for aiding in assembly and operation of the hinge, as well as to accommodate a radius or fillet about a base of the pivot, as shown with respect to FIG. 11B. The first component 1104 also includes a detent 1110 with a chamfer 1112 that may interact with indentations of the second hinge component to provide positive engagement at a first position and a second position.

FIG. 11B illustrates a second component 1124 of a hinge system 1120 of a vehicle indicator system, according to at least one example. The second component 1124 may be connected with a frame 1122 of the vehicle indicator system. The second component 1124 includes a pivot 1126 as well as stops 1128 and 1130. The second component 1124 also includes indentations 1132 and 1136. The pivot 1126 has a chamfer around the end of the pivot 1126 that may enable the pivot to fit within and have clearance within the pocket 1106. The stops 1128 and 1130 are shown as vertical walls that extend parallel with an axis of rotation for the hinge system 1120 to prevent over-rotation of the hinge system by stopping the detent 1110 from rotating past the stops 1128 and 1130. The indentations 1132 and 1136 include chamfers 1134 and 1138 to enable the detent 1110 to move into and out of the indentations 1132 and 1136 as the hinge system is rotated.

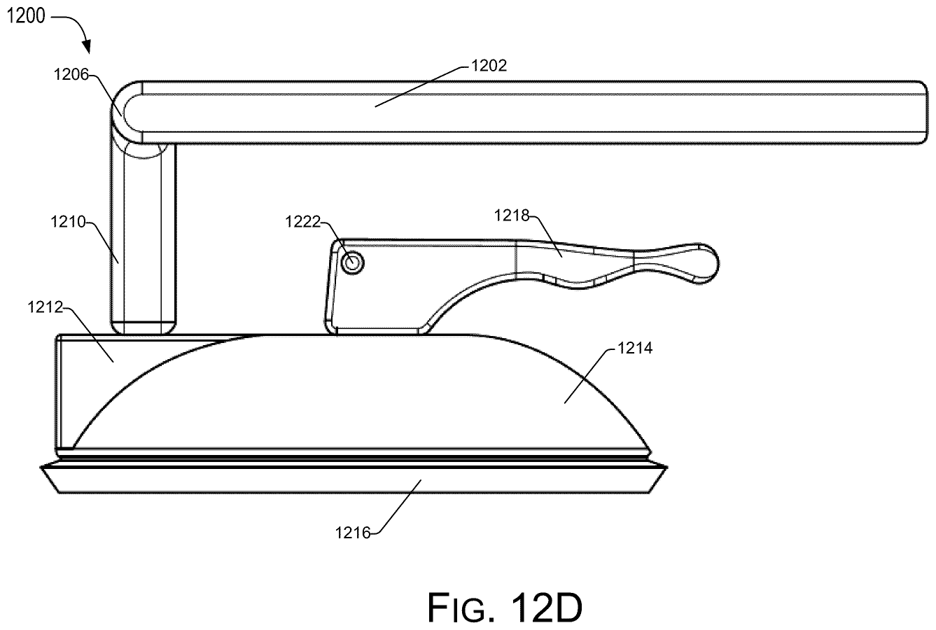

FIGS. 12A-12D illustrate views of a vehicle indicator system 1200, according to at least one example. The vehicle indicator system 1200 may be an example of a vehicle parking indicator attachment as described herein. The vehicle indicator system 1200 may be formed of various materials such as metals, plastics, rubber, composites, and other such suitable materials. The vehicle indicator system 1200 includes a frame 1202 that may receive or support a sign, placard, or other informational device such as a display and couples to the exterior of a window of a door. The frame 1202 defines a perimeter with a channel 1204 to receive a sign or other such component within the frame 1202.

The vehicle indicator system 1200 includes a hinge system that connects the frame 1202 to a base 1212. The hinge system may include the components shown and described with respect to FIGS. 9A-E herein. The hinge system includes first hinge components 1206 and second hinge component 1208. The hinge system enables rotation of the first hinge components 1206 (and the corresponding frame 1202) relative to the base 1212 to enable the frame 1202 to be pivoted from an extended position to a stowed position and/or to other positions.

The base 1212 connects the frame 1202 to an attachment device though a connector and component 1210 that may include a threaded connector (e.g., a bolt), with the attachment device depicted herein as a suction cup. The attachment device shown herein includes a cup portion 1214, handle 1218 for actuating a diaphragm that extends within the cup portion 1214 from an edge 1216, and a pin 1220 connected to the diaphragm of the suction cup to deform the suction cup and cause a vacuum to be formed within the cup portion 1214 to secure the attachment device to an exterior of a window or vehicle panel. The pin 1220 is connected to the handle 1218 through a pin 1222 such that rotation of the handle 1218 causes the pin 1220 to move relative to the cup portion 1214 and diaphragm and cause the suction cup to create a vacuum within the cup portion 1214 and secure the attachment device to the vehicle.

FIGS. 12A, 12C, and 12D illustrate the vehicle indicator system 1200 in a folded configuration folded into a stowed configuration using the hinge system. The vehicle indicator system 1200 is shown in FIG. 12B in an extended configuration with the frame 1202 rotated outwards and extending substantially perpendicular from a side of the vehicle.

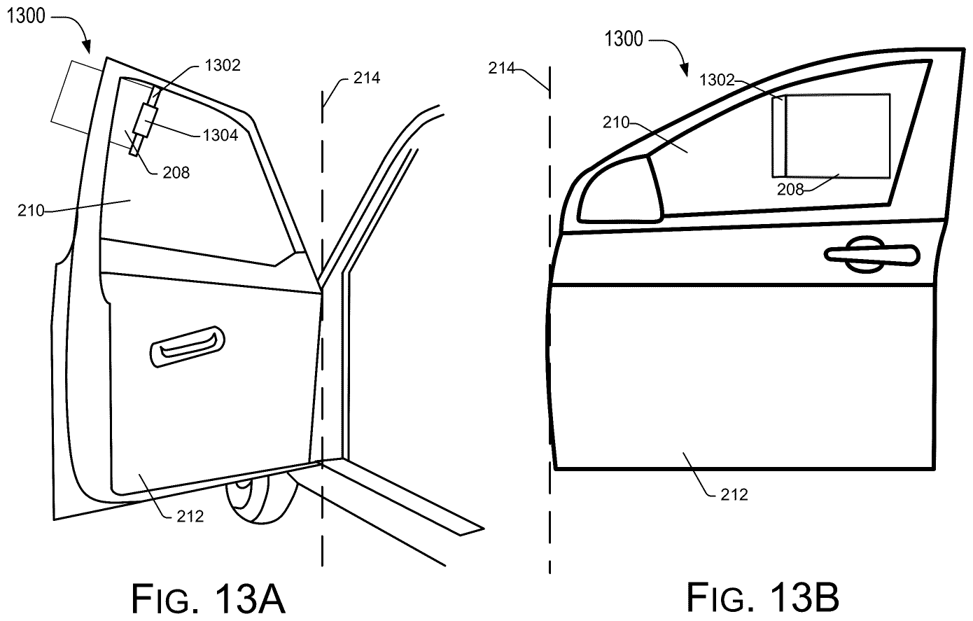

FIGS. 13A-13B illustrate views of a vehicle indicator system 1300 affixed to a vehicle door 212 using a magnetic attachment, according to at least one example. The vehicle indicator system 1300 includes a placard 208 that connects to a window 210 of the door 212. A base 1302 of the vehicle indicator system 1300 connects to the placard 208, which may pivot or rotate relative to the base 1302 to enable the extended and stowed configurations described herein. The base 1302 may include a magnet or magnetic material and an attachment device 1304 may be positioned on an interior of the window 210 and may include a magnet or magnetic material such that the magnet may be used to secure the base 1302 against with window 210. In some examples as described herein, the attachment device and/or strap of various embodiments may include a magnet and/or magnetic material to secure the vehicle indicator system 1300 to the window 210.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A vehicle parking indicator attachment device comprising:
an interior attachment device securable to an interior of a vehicle door;
an exterior attachment device coupleable to the interior attachment device to releasably secure the exterior attachment device to a window of a vehicle; and
a frame connected to the exterior attachment device and configured to support a placard, the frame positionable between a first position and a second position, wherein:
in the first position the frame is substantially perpendicular to the window of the vehicle; and
in the second position the frame is substantially parallel to the window of the vehicle.

2. The vehicle parking indicator attachment device of claim 1, further comprising a strap connecting the interior attachment device to the exterior attachment device, the strap configured to pass between the window and a window frame or a door and a door frame.

3. The vehicle parking indicator attachment device of claim 2, wherein the strap comprises an elastic band.

4. The vehicle parking indicator attachment device of claim 1, wherein the exterior attachment device comprises a suction cup.

5. The vehicle parking indicator attachment device of claim 1, wherein at least one of the interior attachment device or the exterior attachment device comprise a magnet.

6. The vehicle parking indicator attachment device of claim 1, further comprising a hinge coupling the frame to the exterior attachment device.

7. The vehicle parking indicator attachment device of claim 6, wherein the hinge comprises a first detent and a second detent configured to bias positioning of the frame into the first position and the second position using the first detent and the second detent.

8. A parking indicator attachment comprising:
an attachment device configured to secure to a window or exterior panel of a vehicle;
a frame coupled to the attachment device, the frame defining a slot configured to support a placard; and
a hinge operably coupled with the attachment device and the frame, the hinge configured to enable positioning of the frame between a first position and a second position, wherein:
in the first position the frame is substantially perpendicular to the window of the vehicle; and
in the second position the frame is substantially parallel to the window of the vehicle.

9. The parking indicator attachment of claim 8, wherein the attachment device comprises a suction cup engageable with an outer surface of the window.

10. The parking indicator attachment of claim 9, wherein the suction cup is engageable using a handle coupled to the suction cup, the handle configured to change a shape of the suction cup based on a position of the handle to engage with the outer surface of the window.

11. The parking indicator attachment of claim 8, wherein the attachment device is a first attachment device, the parking indicator attachment further comprising a second attachment device, the first attachment device and second attachment device configured to secure the frame to the window.

12. The parking indicator attachment of claim 11, further comprising a strap connecting the first attachment device and the second attachment device.

13. The parking indicator attachment of claim 12, wherein the strap comprises an elastic band.

14. The parking indicator attachment of claim 11, wherein the first attachment device and the second attachment device comprise a magnet and a magnetic device.

15. A device comprising:
an attachment device configured to secure to a window or exterior panel of a vehicle;
a placard coupled to the attachment device; and
a hinge coupled between the attachment device and the placard, the hinge configured to enable positioning of the placard between a first position and a second position, wherein:
in the first position the placard is substantially perpendicular to the window of the vehicle; and
in the second position the placard is substantially parallel to the window of the vehicle.

16. The device of claim 15, wherein the attachment device comprises a suction cup, the suction cup comprising:
a cup portion formed of a rigid material;
an elastic cup portion disposed within the cup portion and secured to an edge of the cup portion; and
a handle positionable between a first position and a second position, wherein in the first position the elastic cup portion has a first shape and in the second position the elastic cup portion has a second shape configured to form a vacuum within a space formed between the elastic cup portion and a surface of the vehicle.

17. The device of claim 15, wherein the attachment device is a first attachment device, the device further comprising a second attachment device, the first attachment device and second attachment device configured to secure the placard to the window.

18. The device of claim 17, further comprising a strap connecting the first attachment device and the second attachment device.

19. The device of claim 18, wherein the strap comprises an elastic band.

20. The device of claim 17, wherein the first attachment device and the second attachment device comprise a magnet and a magnetic device.
